(19) United States
(12) Patent Application Publication
(10) Pub. No.: US 2006/0128340 A1
(43) Pub. Date: Jun. 15, 2006

(54) Radio frequency mixer with notch filter

(76) Inventors: Yong-Hsiang Hsieh, Taoyuan City (TW); Wen-Kai Li, Taipei City (TW); David Jan-Chia Chen, Taipei (TW)

Correspondence Address: LIN & ASSOCIATES INTELLECTUAL PROPERTY, P.O. BOX 2339, SARATOGA, CA, 95070-0339, US

(21) Appl. No.: 11/010,998

(22) Filed: Dec. 11, 2004

(51) Int. Cl. H04B 1/10

(52) U.S. Cl. 455/302; 455/307

(57) ABSTRACT

A mixer with integrated filter for single-ended image rejection is provided, including a single-end to differential (S-to-D) converter, an image rejection notch filer and four Gilbert cell switches. The mixer uses the S-to-D converter as the input cell of the mixer to replace a conventional differential pair circuit. With the converter, the mixer is directly connected to the single-ended LNA, and the output voltage swing of the LNA will be transferred into a differential signal. The image rejection filter is placed between the S-to-D converter and the Gilbert cell switches to filter the image signal from the converter. Thus, only the desired RF signal passing through the Gilbert cell switches will be converted to IF. The notch filter in the mixer of the present invention includes a third-order LC filter and a Q-enhanced circuit. The third-order LC filter has a switch capacitor array to tune both the desired frequency and the image frequency simultaneously. The Q-enhanced circuit includes a programmable current control to adjust the bandwidth and the image rejection of the notch filter.

### FIELD OF THE INVENTION

The present invention generally relates to a structure for a radio frequency mixer, and more specifically to a structure for a radio frequency mixer with an integrated notch filter.

### BACKGROUND OF THE INVENTION

The main function of a radio receiver front-end is to amplify a weak RF signal and mix it with either baseband or intermediate frequency (IF) so that the singal can be easily detected. The former which converts the signal directly to a baseband is known as a homodyne or direct-conversion receiver. The latter which converts the signal some IF is known as a super-heterodyne receiver. Both types of the receivers have strength and weakness, and are suitable for different applications. In a super-heterodyne receiver, one of the inherent problems is the generation of an image frequency signal. An image frequency signal is an undesired input frequency that is capable of producing the same IF that the desired input frequency produces in a radio reception. The term image arises from the mirror-like symmetry of signal and image frequencies about the beating-oscillator frequency. For example, when performing down-conversion, the image frequency, located two IF's away from the desired radio frequency, will be converted to the same IF. Without filtering, the signal to noise ratio eventually decrease by 3 dB and hence the decreasing of receiver sensitivity.

Assuming an intermediate frequency of 455 kHz, the local oscillator will track at a frequency of 455 kHz higher than the incoming signal. For example, suppose the receiver is tuned to pick up a signal on a frequency of 600 kHz. The local oscillator will be operating at a frequency of 1,055 kHz. The received and local oscillator signals are mixed, or heterodyned, in the converter stage and one of the frequencies resulting from this mixing action is the difference between the two signals, or 455 kHz, the IF frequency. This IF frequency is then amplified in the IF stages and sent on to the detector and audio stages. Any signal at a frequency of 455 kHz that appears on the plate of the converter circuit will be accepted by the IF amplifier and passed on. However, if there is a station operating on a frequency of 1,510 kHz, and this signal passes through the rather broad tuned input circuit and appears on the grid of the converter tube, it too will mix with the local oscillator and produce a frequency of 455 kHz (1,510−1,055=455). This signal will also be accepted by the IF amplifier stage and passed on, thus both signals will be heard in the output of the receiver. So any station is likely to experience interference from another station that happens to be on a frequency which is higher than that of the desired station by twice the IF frequency.

Typically there are two types of approaches for performing the on-chip image rejection. One is called pre-filtering by putting an image rejection filter 104 between low noise amplifier (LNA) 102 and mixer 106 to filter out image signals before the down-conversion, as shown in FIG. 1. The other is called post-filtering by using a complex filter 204 to filter out image signals after the down-conversion, as shown in FIG. 2. The latter approach usually provides a higher image rejection ratio, a wider image rejection bandwidth and the immunity to process variation due to lower frequency filtering. But it sacrifices in complexity with quadrature structure, in power consumption with two mixers 206a, 206b and quadrature local generators, and in larger circuitry chip area occupation. In comparison, the former approach is a simpler solution formed by LC circuits, which unfortunately have intrinsic high frequency loss and design difficulty caused by RF filtering. To overcome the loss of RF filter, active Q-enhanced circuits are usually combined with those RF filters to compensate the loss in low-Q on-chip inductors.

It has been demonstrated that the on-chip image filter can be included within a conventional LNA topology to reduce the amplification of an image frequency signal and several designs have employed those filters following LNA. But the conventional high performance notch filters are differential-type circuits and will limit the LNA to differential topology for integration. A differential LNA has the immunity to common mode noise; however, it does not only consume more power to obtain the same noise performance as a single-ended LNA but also requires the additional cost of a balun for connecting to a single-ended off-chip antenna There is, therefore, a need for an image rejection technique that addresses the flexibility usage of single-ended LNA and high performance Q-enhanced notch filter.

### SUMMARY OF THE INVENTION

The present invention has been made to overcome the aforementioned drawback of conventional image rejection methods. The primary object of the present invention is to provide a mixer with a single-to-differential (S-to-D) converter for single-ended image rejection. The mixer the present invention uses a single-end to differential (S-to-D) converter as the input cell of the mixer to replace a conventional differential pair circuit. With the converter, the mixer is directly connected to the single-ended LNA, and the output voltage swing of the LNA will be transferred into a differential signal. The S-to-D converter includes a common source amplifier and a common gate amplifier. The gains of those two amplifiers are identical with the phase difference of 180 degrees. The inputs of the two amplifiers are tied together and the amplifiers can generate differential output. An image rejection filter is placed between the S-to-D converter and the Gilbert cell switches to filter the image signal from the converter. Thus, only the desired RF signal passing through the Gilbert cell switches will be converted to IF.

Another object of the present invention is to provide a mixer with integrated filter to reject image frequency signal. The notch filter in the mixer of the present invention includes a third-order LC filter and a Q-enhanced circuit. The third-order LC filter has a switch capacitor array to tune both the desired frequency and the image frequency simultaneously. The Q-enhanced circuit includes a programmable current control to adjust the bandwidth and the image rejection of the notch filter.

The foregoing and other objects, features, aspects and advantages of the present invention will become better understood from a careful reading of a detailed description provided herein below with appropriate reference to the accompanying drawings.

### BRIEF DESCRIPTION OF THE DRAWINGS

The present invention can be understood in more detail by reading the subsequent detailed description in conjunction with the examples and references made to the accompanying drawings, wherein:

FIG. 1 shows a block diagram of a conventional pre-filtering approach;

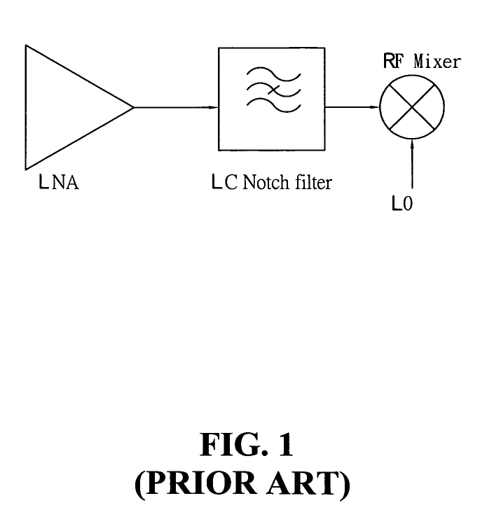

FIG. 2 shows a block diagram of a conventional post-filtering approach;

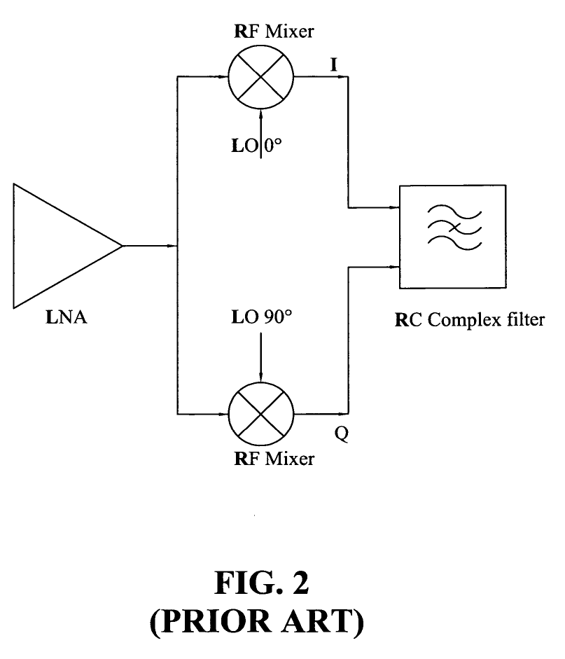

FIG. 3 shows a block diagram of an embodiment of an RF mixer of the present invention; and

FIG. 4 shows a detailed circuitry layout of the embodiment shown in FIG. 3.

### DETAILED DESCRIPTION OF THE PREFERRED EMBODIMENTS

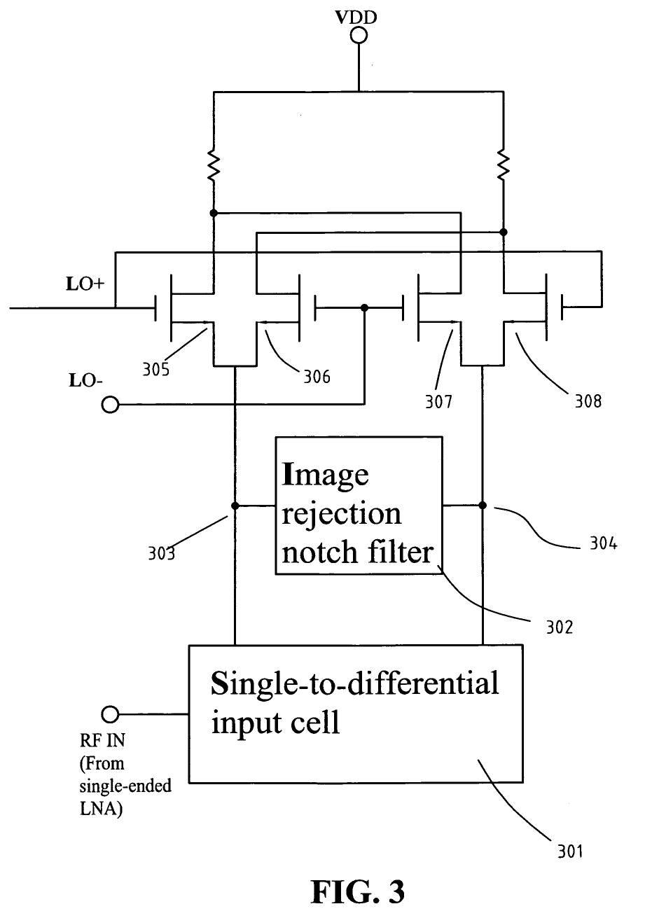

FIG. 3 shows a block diagram of an embodiment of an RF mixer of the present invention, including a single-to-differential (S-to-D) converter 301, an image rejection notch filter 302, and four Gilbert cell switches 305, 306, 307, and 308. Gilbert cell switches 305, 306, 307, and 308 act as a circuit of a conventional mixer. In this embodiment, image rejection notch filter 302 is placed between the differential output of S-to-D converter 301 and the Gilbert cell switches. A power supply V_{DD} is used to drive the sources of the Gilbert cell switches and a local oscillator (LO) is connected to the gates of the Gilbert cell switches.

The RF input from a single-ended LNA first goes to S-to-D converter 301 for converting to a differential signal. It is worth noticing that both the desired frequency signal and the image frequency signal are amplified and converted into the differential signal up to this stage. The image frequency signal in the differential signal is then absorbed by image rejection notch filter 302 coupled between S-to-D converter 301 and Gilbert cell switches 305, 306, 307 and 308, while the desired frequency signal pass through image rejection notch filter 302 to reach Gilbert cell switches 305, 306, 307 and 308 for mixing with LO signals.

The reason that notch filter 302 can absorb the image frequency signal while passing the desired frequency signal lies in the impedance. With the desired frequency, the impedance looking into notch filter 302 is higher than 1/gm_{switch}, the source impedance looking into the Gilbert cell switches. Therefore, no AC current will be drawn away from the original path. On the other hand, with the image frequency, the impedance looking into notch filter 302 is lower; hence, the image signal current will be absorbed from the original path. As a result, the image is effectively rejected before the mixing at the Gilbert cell switches.

The quality of the image rejection depends on the difference of the impedances between notch filter 302 and the Gilbert cell switches. At the desired frequency, the former should be higher than the latter, and the larger the difference is, the lower the signal loss is. On the other hand, at the image frequency, the former should be much lower than the latter, and the larger the difference is, the higher the image rejection is. Thus, by adjusting the gm value of Gilbert cell switches 305, 306, 307 and 308, it is possible to achieve both high image rejection and low loss signal filtering.

Furthermore, in a conventional mixer structure where a filter is not present, the parasitic capacitance at nodes 303 and 304 will degrade the noise-reduction performance. Notch filter 302 with a third-order LC circuit does not only reject the image signal, but also diminishes the effect of the parasitic capacitances at nodes 303 and 304. Thus, the inclusion of a notch filter in the mixer of the present invention achieves high image rejection and good noise-reduction performance at the same time.

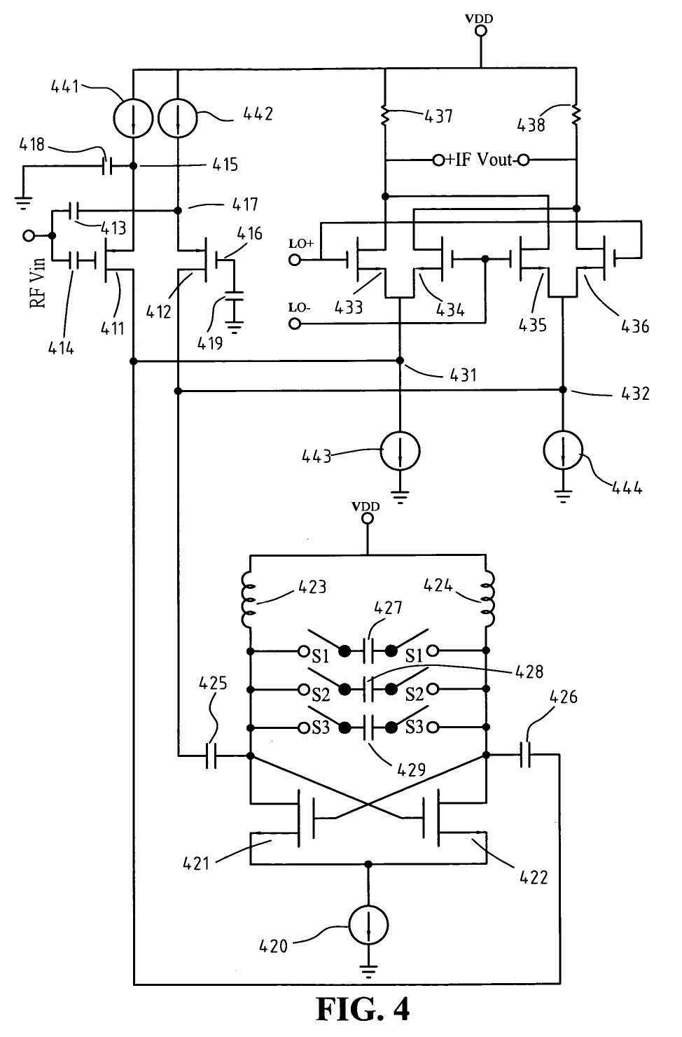

FIG. 4 shows a detailed circuit diagram of the mixer shown in FIG. 3. Two transistors 11, 12 and four capacitors 13, 14, 18, 19 constitute an S-to-D converter circuit (shown as 301 in FIG. 3). Two current sources 41 and 42 are used to drive transistors 11, 12. Two transistors 21 and 22, two inductors 23 and 24, two capacitors 25 and 26, a switch capacitor array with three capacitors 27, 28 and 29, and six switches, constitute a notch filter circuit (shown as 302 in FIG. 3) Gilbert cell switches 433, 434, 435, and 436 form a conventional mixer circuit as in FIG. 3. Two resistors 37 and 38 are placed between the Gilbert cell switches and the V_{DD}.

The mixer is of a folded structure, which has the advantage of allowing the adjustment of the bias current flowing in the current commutating Gilbert switches while current sources 41 and 42 of the S-to-D converter circuit is unaffected. The impedance of Gilbert switches 433-436 can be easily adjusted to obtain high image rejection without changing the gain and the linearity of the S-to-D converter.

It is worth noticing that transistors 11 and 12, biased by current courses 41 and 42, do not form a conventional differential pair. Transistor 11 is a common source (CS) amplifier with a source 15 AC grounded by a capacitor 18. Transistor 12 is a common gate (CG) amplifier with a gate 16 AC grounded by a capacitor 19. Since the phases of a CS amplifier and a CG amplifier are opposite, and their gains are equal, the above arrangement is a method to achieve the single-to-differential conversion process.

The circuit coupled between nodes 31 and 32 is a notch filter, which is used to catch the image signal current without affecting the desired signal current. The notch filter circuit can be divided into two parts: a third-order LC passive filter and a Q-enhanced circuit.

The third-order LC passive filter includes inductors 23 and 24, capacitors 25 and 26, and a frequency tuning switch capacitor array with three capacitors 27-29 and six switches. Switch capacitor array 27-29 is used to tune both the center frequency of the desired signal and the center frequency of the image signal. For example, when all switches S1-s3 are turned on, the impedance looking into the filter can be expressed as:

$${Z}_{m} ( s ) = \frac{{L}_{23} ( {C}_{25} + 2 ⨯ ( {C}_{27} + {C}_{28} + {C}_{29} ) ) ⨯ {S}^{2} + 1}{2 ⨯ ( {C}_{27} + {C}_{28} + {C}_{29} ) {C}_{25} {L}_{23} ⨯ {S}^{3} + {C}_{25} ⨯ S} = \frac{{L}_{24} ( {C}_{26} + 2 ⨯ ( {C}_{27} + {C}_{28} + {C}_{29} ) ) ⨯ {S}^{2} + 1}{2 ⨯ ( {C}_{27} + {C}_{28} + {C}_{29} ) {C}_{26} {L}_{24} ⨯ {S}^{3} + {C}_{26} ⨯ S}$$

By varying the ON/OFF of the switches, the impedance can be changed.

The Q-enhanced circuit includes transistors 21, 22, and a current course 20. This is commonly used in a voltage controlled oscillator design. The Q-enhanced circuit generates a negative impedance to cancel out the loss in the filter caused by low Q of the on-chip inductor 23 and 24. It is worth noticing that the stability of a notch filter means that the gain of the cross coupled transistor pair 21 and 22 should not exceed a certain level. By programmable current source 20 to bias the Q-enhanced circuit, it is possible to control the image rejection depth and the bandwidth of the notch filter.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A radio frequency (RF) mixer for image frequency rejection, comprising:
a single-to-differential (S-to-D) converter having an RF signal input and a pair of different outputs for converting a single-ended input signal to a differential output signal further comprising a desired frequency signal and an image frequency signal;
an image rejection notch filter coupled to said differential outputs of said S-to-D converter for filtering out said image frequency signal from said differential output signal; and
a Gilbert cell mixer having four transistors.

2. The mixer as claimed in claim 1, wherein said notch filter has low impedance at said image frequency and has high impedance at said desired frequency.

3. The mixer as claimed in claim 1, wherein said notch filter further comprises a third-order LC passive filter and a Q-enhanced circuit.
